(19) United States
(12) Patent Application Publication
(10) Pub. No.: US 2004/0100046 A1
(43) Pub. Date: May 27, 2004

(54) Multiple-use cover and carrier for a child safety car seat

(75) Inventor: Sandra M. Darling, Niceville, FL (US)

Correspondence Address: STEVEN C. SCHNEDLER, CARTER SCHNEDLER & MONTEITH, PA, 56 CENTRAL AVE., SUITE 101, PO BOX 2985, ASHEVILLE, NC, 28802, US

(73) Assignee: Blue Ridge International Products Company, Freeport, FL (US)

(21) Appl. No.: 10/701,252

(22) Filed: Nov. 3, 2003

Related U.S. Application Data
(60) Provisional application No. 60/428,732, filed on Nov. 22, 2002.

(51) Int. Cl. B62B 1/10

(52) U.S. Cl. 280/30; 280/47.24; 280/47.26; 280/63

(57) ABSTRACT

A cover and carrier for a child safety car seat usable in either a backpack mode or a luggage mode. A bag-like carrier is made of a flexible sheet material having an exterior surface and defines an interior compartment large enough for the child safety car seat. At least one backpack strap is attached to the bag-like carrier generally on said exterior surface for use in the backpack mode. At least one wheel projects outwardly from said exterior surface at a lower end of the bag-like carrier for use in the luggage mode.

### CROSS-REFERENCE TO RELATED APPLICATION

The benefit of U.S. provisional patent application Ser. No. 60/428,732, filed Nov. 22, 2002 is claimed.

### BACKGROUND OF THE INVENTION

The invention relates generally to covering and transporting child car safety seats.

### SUMMARY OF THE INVENTION

In one aspect, the invention is embodied in a cover and carrier for a child safety car seat usable in either a backpack mode or a luggage mode. A bag-like carrier is made of a flexible sheet material having an exterior surface and defines an interior compartment large enough for the child safety car seat. At least one backpack strap is attached to the bag-like carrier generally on the exterior surface for use in the backpack mode, and at least one wheel projects outwardly from the exterior surface at a lower end of the bag-like carrier for use in the luggage mode.

In another aspect, the invention is embodied in a multiple-use cover and carrier for a child safety car seat. The multiple-use cover and carrier has a travel tote configuration in turn with a backpack mode and a luggage mode as alternatives, as well as a sunshade configuration. A bag-like carrier made of a flexible sheet material has an interior surface and an exterior surface and defines an interior compartment large enough for the child safety car seat. The compartment has an opening comprising a fastener which allows the opening to be repeatedly opened and closed. At least one backpack strap is attached to the bag-like carrier generally on the exterior surface for use in the travel tote configuration backpack mode. At least one wheel projects outwardly from the exterior surface at a lower end of the bag-like carrier for use in the travel tote configuration luggage mode. The bag-like carrier is capable of being turned inside-out through the opening so as to be used in the sunshade configuration as a protective cover for the child safety car seat, with the interior surface generally exposed.

In yet another aspect, the invention is embodied in a multiple-use cover and carrier for a child safety car seat. The multiple-use cover and carrier has a travel tote configuration in turn with a backpack mode and a luggage mode as alternatives, as well as a sunshade configuration. A bag-like carrier is made of a flexible fabric having an interior surface and an exterior surface, and defines an interior compartment large enough for the child safety car seat. The compartment has an opening comprising a fastener which allows the opening to be repeatedly opened and closed. At least one backpack strap is attached to the bag-like carrier generally on the exterior surface for use in the travel tote configuration backpack mode. At least one wheel projects outwardly from the exterior surface at a lower end of the bag-like carrier for use in the travel tote configuration luggage mode. At the lower end of the bag-like carrier is a relatively rigid base to which the at least one wheel is attached via a wheel bracket. The child safety car seat rests upon the base particularly during luggage mode transport. The bag-like carrier is capable of being turned inside-out through the opening so as to be used in the sunshade configuration as a protective cover for the child safety car seat, with the interior surface generally exposed. A portion of the exterior surface comprises a reflective material hemmed by an elastic band to aid in retaining said multiple-use cover and carrier as a protective cover over the child safety car seat in the sunshade configuration.

### BRIEF DESCRIPTION OF THE DRAWINGS

FIG. 1 is rear view (with reference to luggage mode) of a bag-like cover and carrier embodying the invention;

FIG. 2 is an enlarged view of a portion of FIG. 1, as indicated, showing the location of an identification tag;

FIG. 3 is an enlarged view of a portion of FIG. 1, as indicated, illustrating the manner in which the backpack straps are adjusted;

FIG. 4 is an enlarged view of a portion of FIG. 1, as indicated, showing a stowage compartment for the backpack straps when not in use;

FIG. 5 is a rear view showing the bag-like cover and carrier used as a travel tote in its luggage mode, employing built-in wheels;

FIG. 6 is a partial front view (with reference to luggage mode) and shows the bag-like cover and carrier being employed in its backpack configuration;

FIG. 7 is a partial front view (with reference to luggage mode) of the bag-like cover and carrier, showing a child car safety seat being placed inside;

FIG. 8 is a side view, partially broken away, showing the child car safety seat secured within the bag-like cover and carrier;

FIG. 9 is a partial front view (with reference to luggage mode) of the bag-like cover and carrier, showing the location of a channel-like base;

FIG. 10 shows the cover and carrier with fabric portions thereof rolled up for storage;

FIG. 11 depicts the bag-like cover and carrier in the process of being reversed or turned inside out for use in its sun shade cover configuration;

FIG. 12 is an enlarged view of a portion of FIG. 11, as indicated, depicting an elastic band;

FIG. 13 is a view of the bag-like cover and carrier in its reversed or inside-out configuration being zipped shut in preparation for use as a protective sun shade cover;

FIG. 14 depicts the bag-like cover and carrier in its sun shade configuration being placed over the child safety seat secured in a vehicle; and

FIG. 15 depicts the bag-like cover and carrier fully installed in its reversed, sun shade configuration.

### DETAILED DESCRIPTION

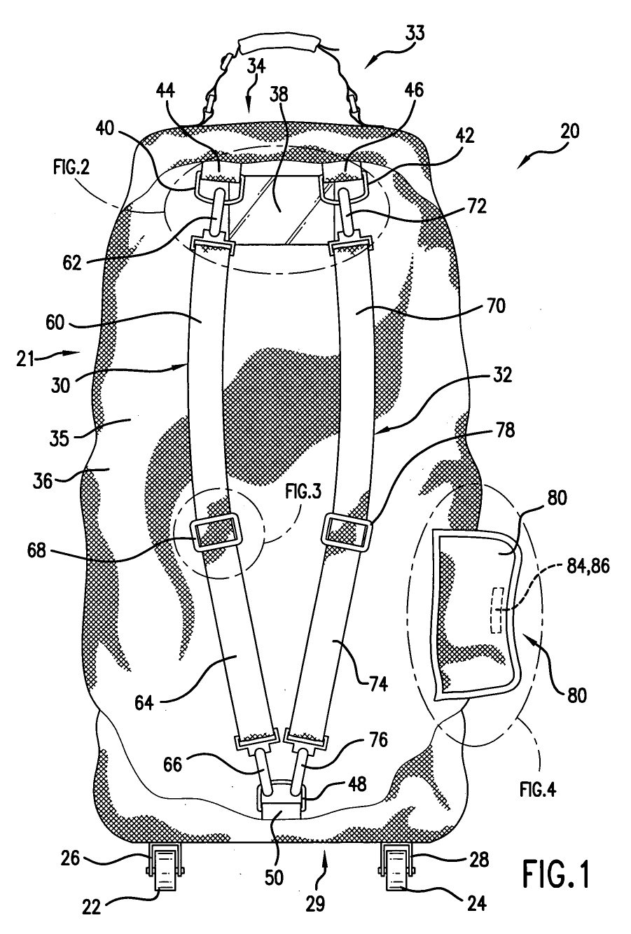

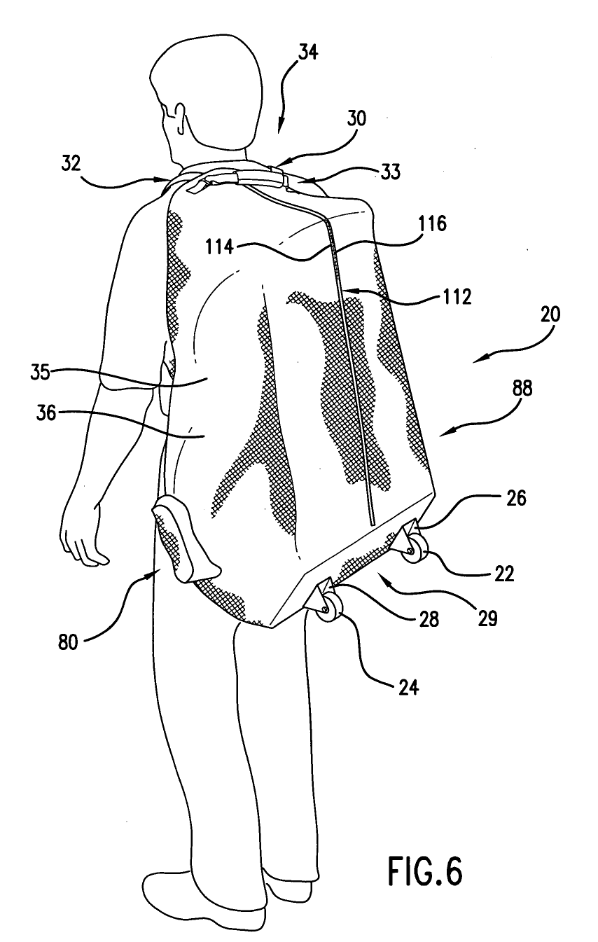

Referring first to FIG. 1, a bag-like cover and carrier 20 embodying the invention is shown generally in its travel tote configuration, viewed generally from a first major side 21. In the travel tote configuration the cover and carrier 20 is usable alternatively either in a luggage mode as illustrated in FIG. 5 described hereinbelow, or in a backpack mode as illustrated in FIG. 6 described hereinbelow. FIG. 1 may also be referred to as a rear view with reference to the luggage mode.

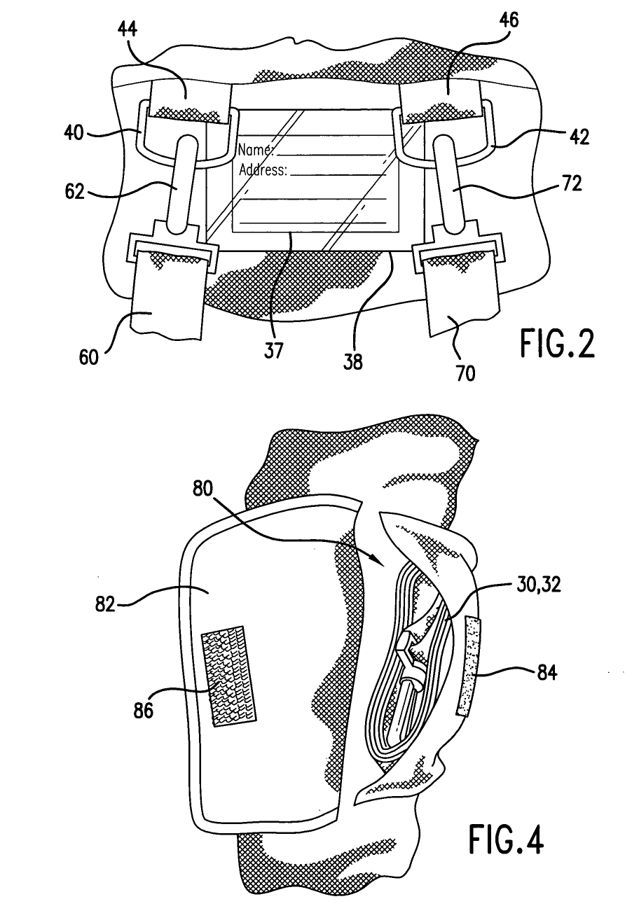

A pair of rubber wheels 22 and 24 and respective metal wheel brackets 26 and 28 (used in luggage mode) project at a bottom or lower end 29 of the cover and carrier 20. Also visible are a pair of backpack straps 30 and 32 (used in backpack mode). A handle 33 at the top or upper end 34 of the bag-like cover and carrier 20 is particularly useful during luggage mode. The bag-like cover and carrier 20 is made generally of a flexible sheet material 35 such as a water resistant polyester fabric, and has an exterior surface 36 visible in FIG. 1. As is shown in the enlarged view of FIG. 2, an identification label 37 is secured behind a transparent plastic panel 38 near the top 34 of the cover and carrier 20.

For attaching the backpack straps 30 and 32, there are a pair of D-rings 40 and 42 with corresponding sewn attachment webs 44 and 46 near the top 34 of the cover and carrier 20, and a single D-ring 48 and a sewn attachment web 50 near the bottom 29 of the cover and carrier 20, all generally on the exterior surface 36 on the first major side 21.

The backpack strap 30 more particularly comprises an upper web 60 terminating in a hook 62 which releasably attaches to the D-ring 40, a lower web 64 terminating in a hook 66 which releasably attaches to the bottom D-ring 48, and an adjustment buckle 68 connecting the upper and lower webs 60 and 64.

Likewise, the backpack strap 32 more particularly comprises an upper web 70 terminating in a hook 72 which releasably attaches to the D-ring 42, a lower web 74 terminating in a hook 76 which releasably attaches to the bottom D-ring 48, and an adjustment buckle 78 connecting the upper and lower webs 70 and 74.

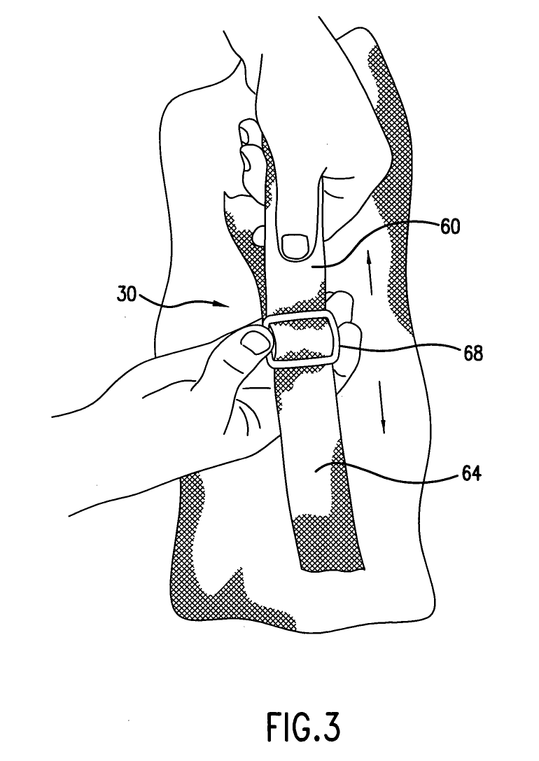

The enlarged view of FIG. 3 more particularly illustrates adjustment of representative adjustment buckle 68 connecting the upper and lower webs 64 of the backpack strap 30.

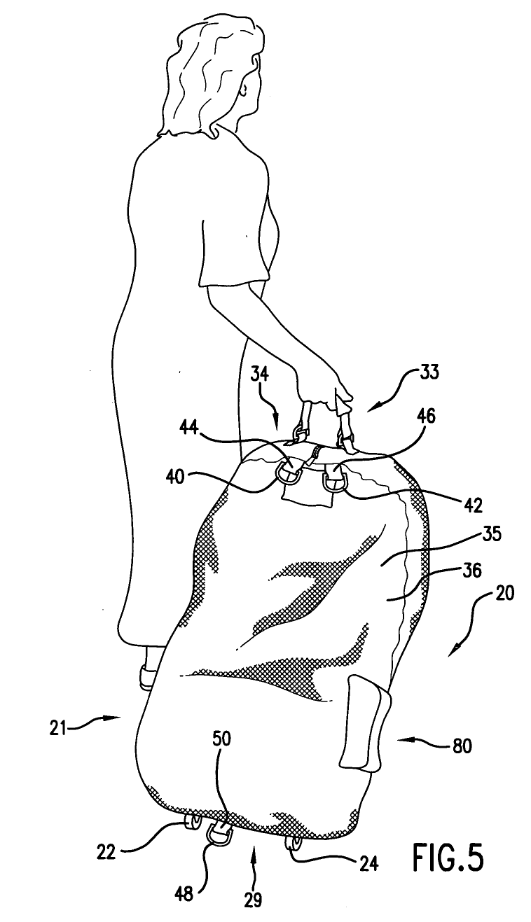

When the cover and carrier 20 is not in use as a backpack, the backpack straps 30 and 32 are detached by unfastening the hooks 62, 66, 72 and 76, and the straps 30 and 32 are placed in strap stowage compartment 80, shown enlarged in FIG. 4. The stowage compartment 80 has a closure flap 82 secured by hook and loop fastener elements 84 and 86.

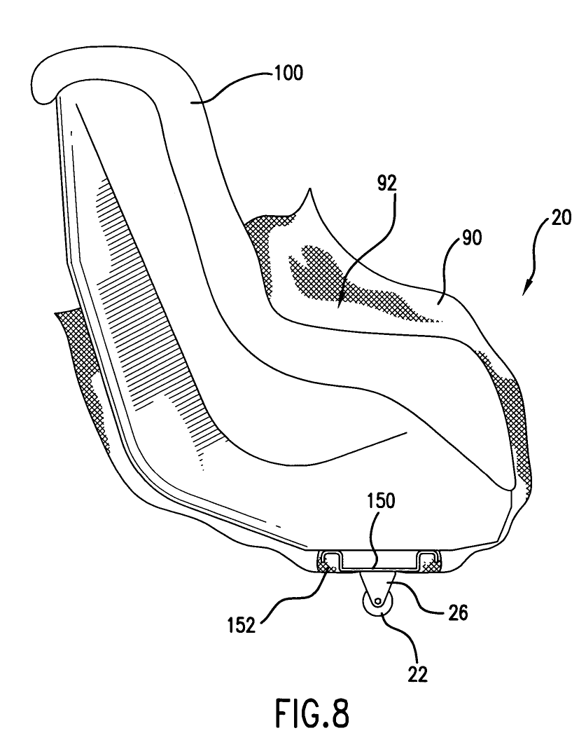

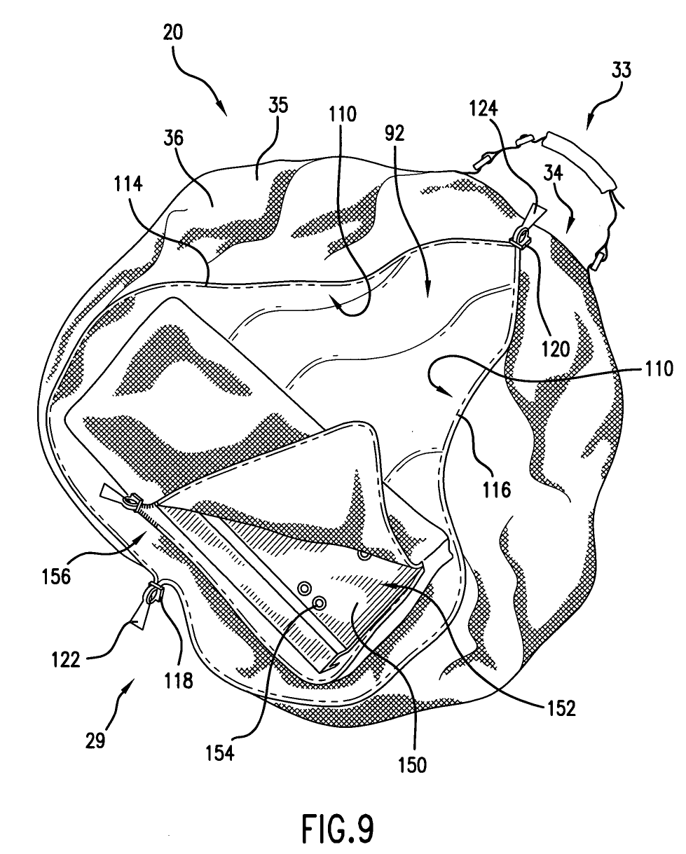

FIG. 5, which also is a view generally from the first major side 21, shows the cover and carrier 20 in use in the luggage mode of the travel tote configuration. As indicated in FIG. 5, the wheels 22 and 24, in combination with the handle 33, are particularly useful when the bag-like cover and carrier 20 is employed in luggage mode. The manner of attachment of the wheel brackets 26 and 28 (FIGS. 1 and 6) to the cover and carrier 20 is described in greater detail hereinbelow with reference to FIGS. 8 and 9. In general, the wheel brackets 26 and 28 (FIGS. 1 and 6) and wheels 22 and 24 project outwardly from the exterior surface 36 at the lower end 29 of the bag-like cover and carrier 20. In FIG. 5, the backpack straps 30 and 32 are stowed within the compartment 80 and are not visible.

FIG. 6 shows the cover and carrier 20 in use in the backpack mode of the travel tote configuration, employing the backpack straps 30 and 32, which however are largely hidden in FIG. 6. In FIG. 6 a second major side 88 is visible, opposite the first major side of FIGS. 1 and 5. In the FIG. 6 backpack mode, the wheels 22 and 24, as well as the handle 33, are exposed, but are not functioning. FIG. 6 may also be referred to as a partial front view with reference to luggage mode.

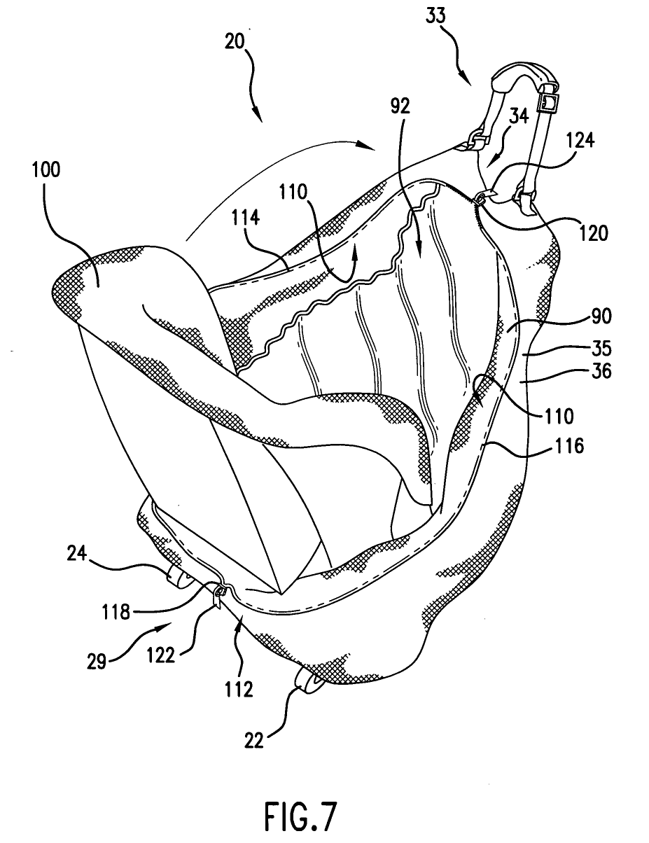

As may be seen in FIG. 7, the polyester fabric flexible sheet material 35 has an interior surface 90 in addition to the exterior surface 36, and defines an interior compartment 92 large enough for a child safety car seat 100. Thus, the interior of the bag-like cover and carrier 20 comprises the compartment 92 which is accessed via an opening 110 including a fastener 112 which allows the opening 110 to be repeatedly opened and closed. In the illustrated embodiment the fastener 112 is a zipper closure, generally designated 112, including two rows 114 and 116 of interlocking teeth, and a pair of sliding tabs 118 and 120 having respective reversible pulls 122 and 124 which are also accessible when the bag-like cover and carrier 20 is turned inside out or reversed for use as a sun shade as is described hereinbelow with particular reference to FIGS. 9-13. Other fasteners may be employed, such as a hook-and-loop fastener (not shown).

FIG. 7 also illustrates the manner in which the representative child car safety seat 100 is placed within the interior compartment 92 when the bag-like cover and carrier 20 is to be used as a travel tote, either in luggage mode (FIG. 5) or backpack mode (FIG. 6). Thus, the zipper closure 112 is opened, generally from what may be viewed as the “front” side with reference to luggage mode. Although a representative rear-facing child car safety seat 100 is illustrated, the bag-like cover and carrier 20 embodying the invention can be employed to transport and protect a variety of child car safety seats including infant, convertible and booster car seats.

The broken away view of FIG. 8 shows the child car safety seat 100 within the interior compartment 92 of the cover and carrier 20, and additionally more particularly shows the mounting of the wheels 22 and 24 and the wheel brackets 26 and 28.

Referring to FIG. 9 in addition to FIG. 8, within the bag-like cover and carrier 20 is a relatively rigid channel-like base 150 to which the wheel brackets 26 and 28 are attached, such as by riveting 154, and on which the child car safety seat 100 rests, particularly during luggage mode transport. In the illustrated embodiment, the channel-like base 150 is made of plastic, but metal may as well be employed. The channel-like base 150 is held within a lateral pocket 152 made of fabric, thereby positively positioning the channel-like base 150 and the fabric 35 of the bag-like cover and carrier 20 in general with reference to each other. Because it is difficult to sew the pocket 152 around the channel-like base 150, a zipper closure, generally designated 156, is employed as part of the pocket 152.

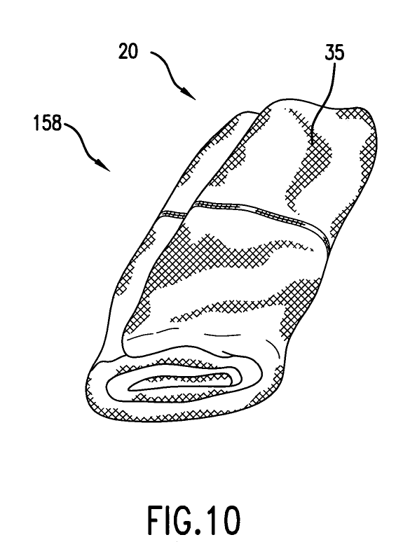

With reference to FIG. 10, an advantage of the disclosed cover and carrier 20, combining the flexible fabric 35 with the smaller channel-like base 150 (not visible in FIG. 10), is that, when not in use, the fabric 35 can be wrapped around the channel-like base 150, resulting in a relatively compact package 158 for storage. The fabric 35 of the cover and carrier 20 is simply rolled up, starting at the bottom 29 (not visible in FIG. 10), around the base 150. The wheels 22 and 24 are padded and hidden within the rolled-up fabric 35, and likewise are not visible in FIG. 10.

With reference generally to FIGS. 10-14, in addition to its use as a travel tote in the travel tote configuration, the bag-like cover and carrier 20 may be employed as a sunshade in a sunshade configuration to protect a child car safety seat secured in a vehicle. Accordingly, the cover and carrier may also be referred to as a multiple-use cover and carrier 20 for a child safety car seat.

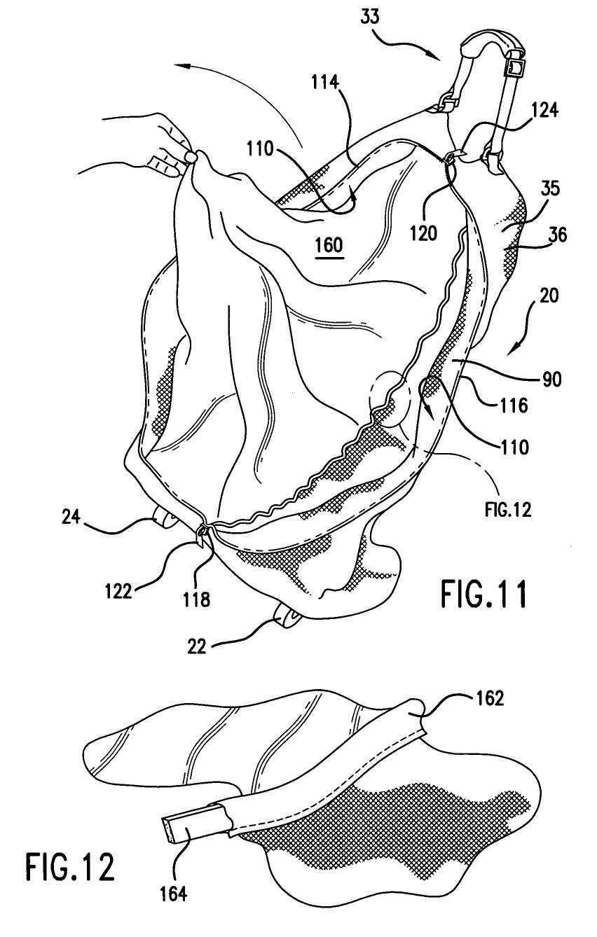

FIG. 11 shows the beginning of the process of reversing or turning the multiple-use cover and carrier 20 inside out. A portion 160 of the interior surface 88 comprises a reflective material, such as nylon with a reflective silvery coating. The edges of the reflective surface portion 160 are defined by a hem 162 within which an elastic band 164 is stitched, as is shown in greater detail in the enlarged view of FIG. 12.

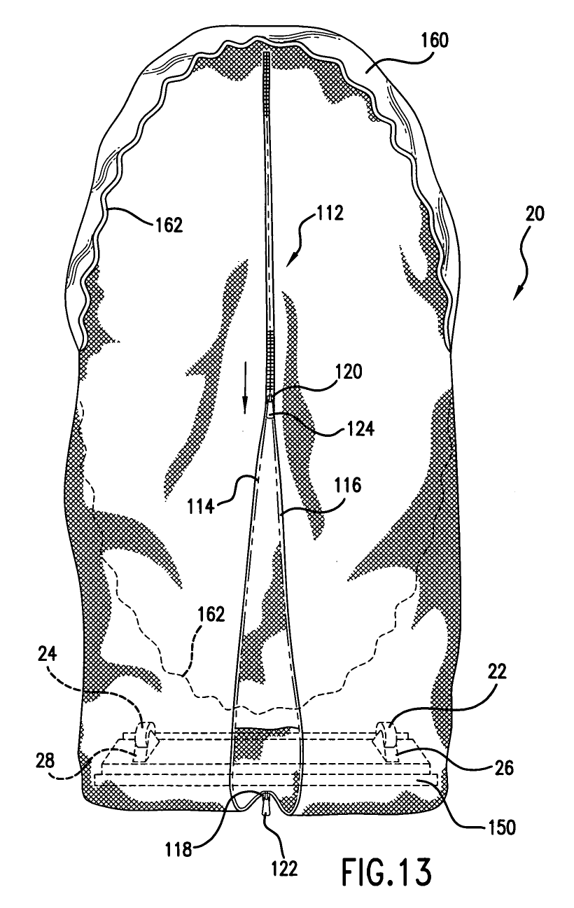

FIG. 13 depicts the multiple-use cover and carrier 20 in the final stages of being turned inside-out, with the zipper closure 112 being closed, employing the reversible pulls 122 and 124 of the sliding tabs 118 and 120. In FIG. 13, the wheels 22 and 24 and wheel brackets 26 and 28, as well as the handle 33, are within the reversed interior and are not functioning.

In the reversed or inside-out sun shade configuration, nothing is placed “inside” the multiple-use cover and carrier 20. It is employed simply as a protective cover for the child safety car seat 100, retained with the aid of the elastic band 164 within the hem 162.

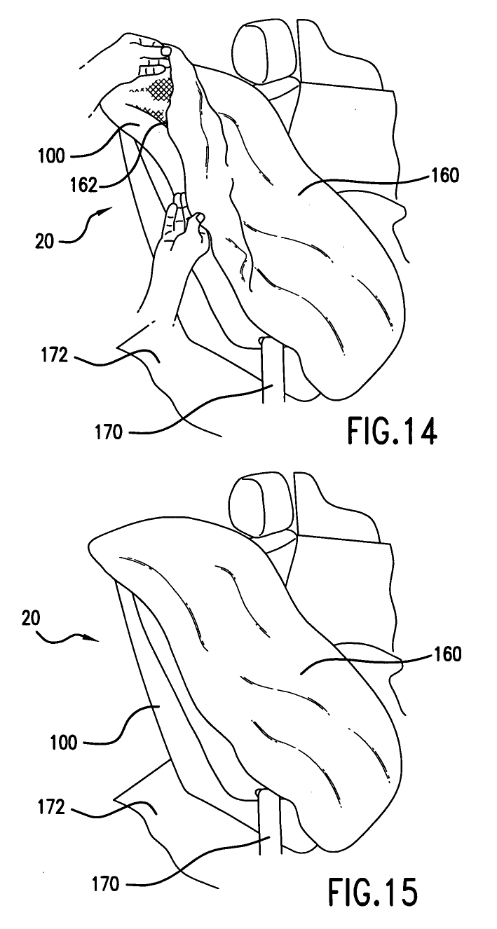

Thus, referring finally to FIGS. 14 and 15, the multiple-use cover and carrier 20 in its reversed or inside-out configuration is shown being used as a sun shade to protect the child car safety seat 100 which is secured by means of an automobile seatbelt 170 to an automobile rear seat 172. The particular child car safety seat 100 illustrated is a rear-facing child car safety seat. FIG. 14 more particularly depicts the multiple-use cover and carrier, now being employed as a cover in the final stages of being placed over the child car safety seat 100, and FIG. 15 depicts the final result. The child car safety seat 100 is not covered in its entirety, only the interior thereof.

While specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

What is claimed is:

1. A cover and carrier for a child safety car seat usable in either a backpack mode or a luggage mode, comprising:
a bag-like carrier made of a flexible sheet material having an exterior surface and defining an interior compartment large enough for the child safety car seat;
at least one backpack strap attached to said bag-like carrier generally on said exterior surface for use in the backpack mode; and
at least one wheel projecting outwardly from said exterior surface at a lower end of said bag-like carrier for use in the luggage mode.

2. The cover and carrier of claim 1, wherein said flexible sheet material comprises fabric.

3. The cover and carrier of claim 1, wherein said at least one backpack strap is releasably attached.

4. The cover and carrier of claim 3, which further comprises a stowage compartment for said backpack strap.

5. The cover and carrier of claim 1, which further comprises a handle at an upper end of said bag-like carrier for use in the luggage mode.

6. The cover and carrier of claim 1, which further comprises a relatively rigid base at said lower end of said bag-like carrier, to which base said at least one wheel is attached via a wheel bracket, and upon which base the child safety car seat rests particularly during luggage mode transport.

7. The cover and carrier of claim 6, wherein said base is secured within a pocket made of fabric, located generally on the inside of said bag-like carrier.

8. The cover and carrier of claim 6, wherein said flexible sheet material can be wrapped around said base to form a compact package for storage.

9. A multiple-use cover and carrier for a child safety car seat, said multiple-use cover and carrier having a travel tote configuration with a backpack mode and a luggage mode as alternatives, and having a sun shade configuration, comprising:
a bag-like carrier made of a flexible sheet material having an interior surface and an exterior surface and defining an interior compartment large enough for the child safety car seat, said compartment having an opening comprising a fastener which allows the opening to be repeatedly opened and closed;
at least one backpack strap attached to said bag-like carrier generally on said exterior surface for use in the travel tote configuration backpack mode;
at least one wheel projecting outwardly from said exterior surface at a lower end of said bag-like carrier for use in the travel tote configuration luggage mode; and
said bag-like carrier being capable of being turned inside-out through said opening so as to be used in the sun shade configuration as a protective cover for the child safety car seat, with said interior surface generally exposed.

10. The multiple-use cover and carrier of claim 9, wherein said flexible sheet material comprises fabric.

11. The multiple-use cover and carrier of claim 9, wherein a portion of said interior surface comprises a reflective material.

12. The multiple-use cover and carrier of claim 11, wherein said reflective material portion is hemmed by an elastic band to aid in retaining said multiple-use cover and carrier as a protective cover over the child safety car seat in the sun shade configuration.

13. The multiple-use cover and carrier of claim 9, wherein a portion of said interior surface is hemmed by an elastic band to aid in retaining said multiple-use cover and carrier as a protective cover over the child safety car seat in the sun shade configuration.

14. The multiple-use cover and carrier of claim 9, wherein said fastener for said interior compartment opening comprises a zipper.

15. The multiple-use cover and carrier of claim 14, wherein said zipper comprises at least one sliding tab including a reversible pull which is accessible both when said multiple-use cover and carrier is in its travel tote configuration with the exterior surface facing outward and when said multiple-use cover and carrier is turned inside out in its sun shade configuration.

16. The multiple-use cover and carrier of claim 9, wherein said at least one backpack strap is releasably attached.

17. The multiple-use cover and carrier of claim 16, which further comprises a stowage compartment for said backpack strap.

18. The multiple-use cover and carrier of claim 9, which further comprises a handle at an upper end of said bag-like carrier for use in the travel tote configuration luggage mode.

19. The multiple-use cover and carrier of claim 9, which further comprises a relatively rigid base at said lower end of said bag-like carrier, to which base said at least one wheel is attached via a wheel bracket, and upon which base the child safety car seat rests particularly during luggage mode transport.

20. The multiple-use cover and carrier of claim 19, wherein said base is secured within a pocket made of fabric located generally on the inside of said bag-like carrier.

21. The multiple-use cover and carrier of claim 19, wherein said flexible sheet material can be wrapped around said base to form a compact package for storage.

22. A multiple-use cover and carrier for a child safety car seat, said multiple-use cover and carrier having a travel tote configuration with a backpack mode and a luggage mode as alternatives, and having a sun shade configuration, comprising:
a bag-like carrier made of a flexible fabric having an interior surface and an exterior surface and defining an interior compartment large enough for the child safety car seat, said compartment having an opening comprising a fastener which allows the opening to be repeatedly opened and closed;
at least one backpack strap attached to said bag-like carrier generally on said exterior surface for use in the travel tote configuration backpack mode;
at least one wheel projecting outwardly from said exterior surface at a lower end of said bag-like carrier for use in the travel tote configuration luggage mode;
a relatively rigid base at said lower end of said bag-like carrier, to which base said at least one wheel is attached via a wheel bracket, upon which base the child safety car seat rests particularly during luggage mode transport, and around which base said flexible sheet material can be wrapped to form a compact package for storage; and
said bag-like carrier being capable of being turned inside-out through said opening so as to be used in the sun shade configuration as a protective cover for the child safety car seat, with said interior surface generally exposed, a portion of said interior surface comprising a reflective material hemmed by an elastic band to aid in retaining said multiple-use cover and carrier as a protective cover over the child safety car seat in the sun shade configuration.
